(19) United States
(12) Patent Application Publication
(10) Pub. No.: US 2026/0014577 A1
(43) Pub. Date: Jan. 15, 2026

(54) COATING APPARATUS FOR SURFACE REFINEMENT OF A WORKPIECE

(71) Applicant: HPL TECHNOLOGIES GMBH, Aachen (DE)

(72) Inventor: Tobias Phillip UTSCH, Wetzlar (DE)

(73) Assignee: HPL TECHNOLOGIES GMBH, Aachen (DE)

(21) Appl. No.: 18/683,736

(22) PCT Filed: Aug. 16, 2022
(86) PCT No.: PCT/DE2022/100607

§ 371 Date: Sep. 26, 2025

(30) Foreign Application Priority Data
Aug. 16, 2021 (DE) 10 2021 208 974.7

(51) Int. Cl. B05B 12/08; B05B 7/22; B05B 13/02

(52) U.S. Cl. CPC B05B 12/084; B05B 7/228; B05B 13/0228

(57) ABSTRACT

The invention relates to a coating device for surface finishing of a workpiece, comprising at least the following components:
a tool chuck for holding a workpiece with a treatment surface;
a coating unit with an application axis for application of a finishing layer in a region and along a feeding direction on said treatment surface; and
an optical monitoring unit by means of which an application operation on said treatment surface can be detected in a focus region.

The coating device is characterized especially in that the focus region of the monitoring unit is directed onto the region of the current application operation upstream of the region in the feeding direction and/or at an inclination with respect to the application axis. With the coating device proposed here, the application quality can be monitored in-line in the coating process.

The invention relates to a coating apparatus for the surface refinement of a workpiece, as well as a coating method using one such coating apparatus in a surface refinement of a workpiece.

In order to meet cost pressure and, at the same time, the high requirements particularly regarding performance and environmental impact made of a workpiece, cost-effective manufactured carrier materials are increasingly used which obtain a functional coating. For example, it is known to produce brake discs for motor vehicles and utility vehicles using a cast body (carrier material) and to equip the surface interacting with the respective brake pad with a refinement layer. Currently, the properties of a refinement layer of this sort are frequently unknown. Deviations from a desired property are compensated by applying refinement material in large layer thicknesses and by post processing. This results in higher material costs and long processing times.

Starting from here, the task upon which the present invention is based is to overcome at least partially the disadvantages known from the state of the art. The characteristics according to the invention result from the independent claims, and advantageous embodiments of the are shown in the dependent claims. The characteristics of the claims can be combined in any technically sensible manner, wherein in this regard the explanations from the following description as well as characteristics from the figures can also be used to produce supplemental embodiments of the invention.

The invention relates to a coating apparatus for the surface refinement of a workpiece, having at least the following components:
a tool chuck holding a workpiece having a treatment surface;
a coating unit having an application axis for applying a refinement layer, in a region and along a feed direction, onto that treatment surface; and
an optical monitoring unit, by means of which an application procedure on that treatment surface is detectable in a focus region.

The coating apparatus is most importantly characterized in that the focus region of the monitoring unit is aligned in the feed direction in front of the region and/or from inclined to the application axis onto the region of the current application procedure.

Hereinafter, reference will be made to the mentioned rotation axis, when without an explicit indication to the contrary, the axial direction, radial direction or the circumferential direction and corresponding terms are used. Ordinal numbers used in the previous and following description serve, insofar as there is no indication to the contrary, only for clear distinguishability and constitute no sequence or priority of the described components. An ordinal number greater than one does not mean that a further component of this sort necessarily needs to be present.

The workpiece to be treated has in a state prior to the application of a refinement layer a (free) treatment surface. For example, the treatment surface is a (for example machined) metal surface, for example of a poured body. The workpiece or a part of the workpiece forms a carrier body or a part of a carrier body, wherein the carrier body has suitable mechanical properties, for example for transferring forces and moments. Examples are a brake disc, a piston for a hydraulic system, a cylinder running surface for an internal combustion engine.

The coating apparatus is configured for applying a refinement layer onto the treatment surface of the workpiece. Examples are so-called additive production methods, in which by means of (hard) soldering or welding a refinement material is material-fittingly bonded with the treatment surface. The necessary thermal input is provided for example by a flame (for example HVOF; High Velocity Oxygen Fuel), an electric arc (for example PTA) for a laser (laser deposition welding, in particular extreme high speed laser deposition welding [EHLA] as known from DE 10 2011 100 456 A1). The material is provided for example as wire or powder (mixture). Frequently, a carrier gas is used for transporting the powder particles and/or a protective gas for generating a desirable reaction environment. A refinement layer is (statistically) homogeneous and/or constructed of several (possibly different) layers. Frequently, a refinement layer is applied in strips onto the treatment surface, for example in the form of parallel welding beads overlapping one another. In an advantageous embodiment, the coating apparatus is configured for an additive metal coating.

Frequently, a high strength and/or resilience of the refinement layer is required, such as for example a constant friction coefficient over a large temperature change during operation (between for example −60° C. [minus sixty degrees Celsius] and +800° C. [plus eight hundred degrees Celsius] and more in the case of a brake disc). At the same time, in order to save refinement material and in order to reduce production times, a refinement layer which is as thin as possible is applied to the treatment surface. For this, it is advantageous when the properties of the applied refinement layer are known as precisely as possible.

The workpiece to be treated is tensioned in a tool chuck and held thereby in a precisely positioned manner. For a rotation workpiece, the tool chuck is for example a clamping chuck. For a workpiece to be treated linearly or in a translational manner, the tool chuck is for example a work platform with a clamp. The tool chuck is rigid (or has a rigid rotation axis) or is movable by means of an actuator linearly along at least one or rotationally about at least one spatial axis.

The coating unit is the functionally central unit of the coating apparatus. For example, the coating unit has a welding head, a material supply, a surface cooling device and/or a protective gas supply. The coating unit is movable for a feed (relative movement between workpiece and coating unit) preferably along at least one spatial axis relative to the workpiece held in the tool chuck. Alternatively or additionally, a feed motion is executable by means of a movement of the tool chuck.

Here it is proposed that the coating apparatus comprises an optical monitoring unit which is configured for detecting (in a focus region) the coating procedure (by means of the coating unit) on the treatment surface. The optical monitoring unit aligned onto the surface of the workpiece, such that the processes when applying the coating material are optically detected. The coating procedure is thus able to be monitored in situ and thus a quality of the applied material or of the connection of the applied material treatment surface of the workpiece is monitorable during the production process.

At this point, it is now proposed that the focus region of the monitoring unit in an embodiment is aligned in front of the region in which the monitoring currently takes place. It is thus monitorable in which state the treatment surface is, or whether a coating has already taken place here as a result of an error in the application (for example splashes caused by an erroneous supply of the coating material).

In another embodiment, the focus region is aligned from an angle to the application axis of the coating unit, such that a height information is retrievable in this regard and/or a distortion of the measurement resulting from a heat source of the coating unit (for example a flame or a laser beam) is avoided.

In an embodiment, both the focus region in front of the region of the application as well as that in the angle of the monitoring unit onto the focus region is aligned so as to be inclined with relation to the application axis.

For example, a sight line of a monitoring unit onto the focus region is aligned by an angle of between 15° [fifteen degrees of 360°] and 75°, preferably between 30° and 60°, or most preferably at approximately 45° to the application axis, wherein the application axis is preferably aligned surface-normal to the treatment surface.

A particular focus in the application procedure with regard to this monitoring unit relates to detecting the temperature and a height (that is, layer thickness) of the applied refinement layer.

Reference is made to the fact that the optical monitoring unit is moved synchronously with the coating unit, for example is moved together by means of the (optional) feed device for moving the coating unit, or coupled thereto.

In a preferred embodiment, in addition at least one of the following parameters is detected by means of the measuring unit:
an orientation of the workpiece;
an evenness of the treatment surface;
a flat run of the treatment surface; and
in the case of a disc-shaped workpiece (such as for example a brake disc) a shielding of the treatment surface.

Furthermore, it is proposed, in an advantageous embodiment of the coating apparatus, that furthermore a following monitoring unit is provided with a following focus region, wherein the following focus region is aligned in feed direction behind the region of the current application procedure.

In this embodiment, in addition a following monitoring unit is provided, which detects the result of the application procedure. Preferably, this takes place in the immediate vicinity of the application procedure, wherein this is designed as a function of a process velocity and a (temperature and/or hardening) decay velocity in the material application. For example, the spacing is selected such that a time gap between the application procedure and the associated detecting by means of the following monitoring unit is less than 1 s [one second].

In a most preferred embodiment, the following monitoring unit is also aligned inclined at an angle to the application axis, preferably at the same or at a mirrored angle to the application axis.

By means of the following monitoring unit, the cooling of the applied material as well as (preferably simultaneously) a height of the applied material, that is a layer thickness, is detectable. In a preferred embodiment, by means of a further sensor, a (thermal) deformation of the treatment surface is detectable and thus the change in the height detected by the following monitoring unit and the change in the height of the treatment surface is subtractable from one another, in order to be able to determine the precise layer thickness. This information is especially advantageous for a downstream grinding process, since thereby a thinnest point in the refinement layer is determinable and, thus, how much material needs to be removed is determinable and preferably in advance how much material needs to be further applied. In a most preferred embodiment, the measurement data for the workpiece are stored and assigned individually to the workpiece as electronic information and made ready for a customer of the workpiece, such that they obtain detailed information regarding the quality of the workpiece or of its refinement layer, without a (possibly destructive) test of the workpiece being necessary for this purpose, such that 100% examination for each workpiece is present instead of a sample test.

Furthermore, in an advantageous embodiment of the coating apparatus, it is proposed that the coating apparatus comprises an application laser and furthermore an axial monitoring is provided, wherein the axial monitoring unit is coupled into the application laser.

In this embodiment, use is made of the fact that by means of the application laser, an optical sight axis onto the treatment surface is already in existence, which facilitates a coupling-in of the monitoring unit by means of a suitable (inclined) translucent mirror. Reference is made to the fact that different optical measurement procedures and thus a plurality of monitoring units are couplable into the application axis and thus a plurality of items of information is detectable, such as a current temperature and material application (for example a powder spray image of a supplied coating material). In an advantageous embodiment, the measurement data (for example a dot cloud) are visually processed.

Furthermore, in an advantageous embodiment of the coating apparatus, it is proposed that at least one of the monitoring units comprises a video camera and/or a pyrometer.

Here, it is proposed that at least one optical monitoring units is configured for detecting temperature, that is as a so-called pyrometer. In an embodiment, at least one of the monitoring units a video camera, such that a high quantity of information is collectable for a human reading or a controlled closed-loop controlling. In a preferred embodiment, the video camera is a thermal image camera and thus in addition information regarding temperature is collectable regarding the detected elements on the video image.

Furthermore, in an advantageous embodiment of the coating apparatus, it is proposed that the workpiece is a rotation workpiece, preferably a brake disc for a motor vehicle.

Here it is proposed that the workpiece is a rotation workpiece, wherein the rotation workpiece is rotated about a central rotation axis when the refinement layer is applied. Frequently, then, one single feed axis for the coating unit for applying the refinement layer is sufficient. When the treatment surface has a cylindrical shape this feed axis is aligned parallel to the rotation axis (corresponds to the cylinder axis). In the case of a cylinder cover shape, or disc shape, of the treatment surface, this feed axis is aligned parallel to the radius to the rotation axis (corresponds to the cylinder axis or disc axis). Preferably, furthermore, a delivery axis or adjusting axis is provided, wherein most preferably this is movable in a manner adapted to the coating speed or to the measuring speed in the coating process or at the calibration. Alternatively, the delivery axis is only movable more slowly and is set only prior to the start of an application of the refinement layer or of a calibration or of an intermediate step of the procedure concerned.

In an advantageous embodiment, the rotation workpiece is a brake disc for a motor vehicle (including a utility vehicle). The treatment surface is the friction surface which during operation comes into contact with a brake pad when the motor vehicle decelerates. The carrier disc is for example poured, for example of steel or lamellar gray cast iron. The refinement layer comprises carbides which ensure a desired surface coarseness and friction resistance of the finished surface. For example, the refinement layer is a MMC (Metal Matrix Composite), preferably comprising stainless steel as a matrix material. The additives are for example niobium [Nb], silicon [Si], chromium [Cr] and/or titanium [Ti]. The refinement layer in an embodiment is composed of two or more layers of material with different position, wherein for example (preferably exclusively) one binding layer and one friction layer are provided. For the general technical background, reference is made to DE 10 2018 120 897 A1.

In an advantageous embodiment, the refinement layer on the treatment surface of the brake disc has a height difference of maximum 10 μm [ten microns] to 200 μm over the entire surface of the treatment surface. Thereby, a deviation of this sort is in a range admissible for the end state of the brake disc and it is not necessary to remove material for reasons of unevenness in the refinement layer. Alternatively, the height of material to be removed is in the same amount range as for compensating and undulation and/or a maximum difference between the height minimum and the height maximum (for example as is already present on the treatment surface or as was present prior to the coating procedure), wherein preferably it is ensured by means of the above-described monitoring procedure that there is no summation of the effects. A workpiece in which a summation of this sort occurs is discarded as waste or (in individual cases) a greater layer height is applied, or a height minimum is filled in deliberately after the fact. The latter is possible with the above-described monitoring procedure integrated into the coating procedure, since the monitoring unit and the coating unit make reference to one another and thus it is possible to react to a deviation in the application procedure (for example immediately during the application).

In an advantageous embodiment, the optical monitoring unit for determining the shielding comprises a first partial unit for the treatment surface and a second partial unit, referring thereto, for calibrating a height profile of the rear side opposite to the treatment surface, preferably simultaneously axially opposite to the focus region of the first partial unit, and/or preferably simultaneously axially opposite to the region of the current application procedure.

In this embodiment, a simultaneous calibration on both sides of two surfaces opposite one another (axially in relation to the measurement axis), that is of the treatment surface and the rear side, is facilitated. Errors in the workpiece which are present on the two sides of the workpiece, for example an eccentricity, a shielding, or an undulation, can then be taken into consideration. In an embodiment, the coating layer is appropriately guided. In an embodiment, the second height profile (rear side) calibrated by the second partial unit is subtracted from the first height profile (treatment surface with, where appropriate, at least a part of the refinement layer), calibrated by means of the first partial unit. In an embodiment, at least the rear side is calibrated in advance (prior to the application of the refinement layer on the treatment surface) and the results of the calibration are compared during the application or after the application of the refinement layer. Changes are taken into consideration already during the application and/or are used for determining the height of the refinement layer.

When by means of the second partial unit the rear side of the workpiece is calibrated simultaneously axially oppositely to the oppositely-situated focus region on the treatment surface by means of the first partial unit, dynamic changes by means of difference formation in the measurement results can be suppressed. For example, a thermal deformation which occurs temporarily and disappears again is surpressed, inasmuch as it also has an effect on the rear side. Reference is made to the fact that the deformation quantities on the treatment surface and the rear side do not need to be identical or are as a rule not identical even if they have the same cause (for example shielding of a brake disc). These effects can be compensated by means of taking into consideration geometrically clearly specifiable correlations. Alternatively, the differences can be ignored for the required precision of the measurement. The causes can be clearly determined by means of a line measurement or multi-point measurement.

If, by means of the second partial unit, the rear side of the workpiece is calibrated simultaneously and axially oppositely to the region of the current application on the treatment surface by means of the coating unit, dynamic changes when guiding the coating unit can be taken into consideration. For example, a thermal deformation for reasons of a thermal input by means of the coating unit into the treatment surface (for example without thermal effect on the rear side) is detectable in the moment of its occurrence, insofar as the (in some cases one-sided) thermal input results in a deformation on the rear side. In an embodiment, the effect of the one-sided thermal input, mentioned for sake of example, is observed at the same time by the first partial unit with a spacing (radial on a brake disc) from the thermal input, for example (due to thermally-induced shielding), the outer edge of the brake disc can be observed to stand up. Reference is made to the fact that the deformation quantities on the treatment surface and the rear side do not need to be identical or are as a rule not identical even if they have the same cause (for example shielding of a brake disc). These effects can be compensated by means of taking into consideration geometrically clearly specifiable correlations. Alternatively, the differences can be ignored for the required precision of the measurement. The causes can be clearly determined by means of a line measurement or multi-point measurement.

Reference is made to the fact that in an embodiment the measuring unit and/or the partial units detect at one point in time only focus region, for example by means of a video camera. Reference is made to the fact that in an embodiment the measuring unit and/or the partial units detect at one point in time only focus region, for example by means of a video camera. In an embodiment, a line measurement or multi-point measurement is carried out by at least one partial unit and/or sub unit.

In an embodiment, the measuring unit or at least one partial unit is fixed relatively to the coating unit, preferably is carried by the same feed axis.

According to a further aspect, a coating procedure in a surface refinement of a workpiece by means of a coating apparatus according to an embodiment according to the above description is proposed, wherein while a workpiece is held in the tool chuck, the coating procedure comprises at least the following steps:
a. by means of the coating unit, application of a refinement layer on the treatment surface along the feed direction; and
b. by means of the at least one monitoring unit, detecting the application procedure according to step a. on the treatment surface.

The coating procedure proposed here permits a monitoring during the application of the refinement layer on the treatment surface of a workpiece and therewith a huge increase in process safety and precision of the coating (applying the refinement layer). At least optionally, reference is made to the embodiments of a monitoring procedure which have already been mentioned above.

In step a., initially a refinement layer is applied on the treatment surface by means of the coating unit, wherein the application procedure is carried out along a feed direction. In the case of a brake disc, for example the brake disc is tensioned by a tool chuck and rotated about its rotation axis and the coating unit extends radially to the outside (feed direction), such that the refinement layer is applied approximately in the manner of a spiral on the treatment surface of the brake disc. In the case of a piston, the piston is preferably also rotated about its rotation axis and the feed direction of the coating unit is aligned parallel to the piston axis, such that the refinement layer is applied in the manner of a screw onto the treatment surface of the workpiece.

In step b., the treatment surface is monitored, wherein step b. is carried out prior to, during or after step a. Preferably, the detection is carried out simultaneously and only for reasons of the spatial assignment (leading in the focus region in the region of the application current application procedure or trailing) is there a temporal offset to the respectively current application procedure.

Furthermore, in an advantageous embodiment of the coating method, it is proposed that when detecting the application procedure in step b. at least one of the following items of information is determined, specifically a current temperature and/or a height profile:
in the region of the current application;
at a leading distance in the feed direction in front of the region of the current application; and
at a trailing distance in the feed direction behind the region of the current application.

By means of the coating procedure proposed here or the monitoring within the coating procedure, the current temperature and/or a height profile is detected in the region of the current application (preferably by means of a light sensor coupled into the application axis), at a leading distance (preferably at an angle to the application axis) and/or at a trailing distance to the region in which the application is currently taking place. Also in this regard, reference is made to the appropriate description above.

In a most preferred embodiment of the coating method, the detected items of information are referenced to a workpiece-fixed coordinate system and stored, for example as a dot cloud, wherein each point corresponds to an item of information (for example temperature and/or height). In an especially advantageous embodiment, these qualified items of information are obtained at least for a subsequent post-processing procedure (for example grinding), for example in that the orientation of the workpiece remains known by a robot arm or in that the workpiece has an applied or inherent reference mark to which the mapped items of information can repeatedly be precisely aligned. Most especially preferably, these items of data are stored (preferably mapped) and made available to a customer.

In an advantageous embodiment a shielding of the rotation workpiece is determined by means of the optical monitoring unit.

Preferably, a monitoring unit provided for determining the shielding has two partial units, as previously described. In this regard, the two partial units are aligned onto the workpiece from two oppositely-situated sides.

In an embodiment, a rotation workpiece is coated by means of the coating procedure, which workpiece has in the region of the refinement layer a maximum height difference of 10 μm to 70 μm; and a height of the surface of the refinement layer of minimum 50 μm to maximum 400 μm.

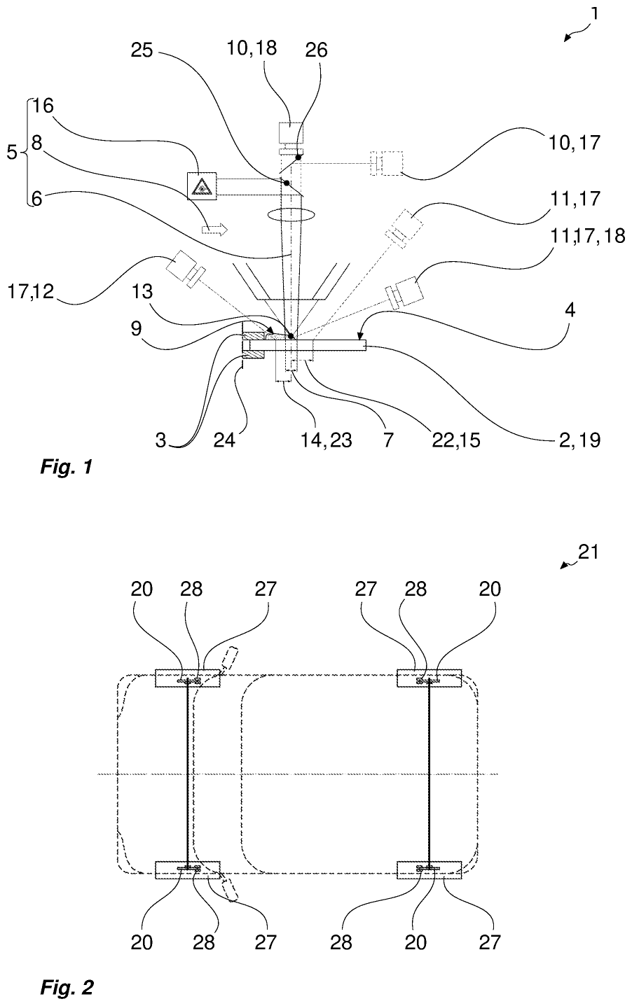

The above-described invention is hereinafter described in detail against the corresponding technical background with reference to the attached drawings which show preferred embodiments. The invention is in no way limited by the purely schematic drawings, wherein it is to be noted that the drawings are not to scale and are not suitable for the definition of proportions. Shown in
FIG. 1: a coating apparatus with clamped workpiece; and
FIG. 2: a motor vehicle with brake disc in a schematic top view.

In FIG. 1 is shown a coating apparatus 1 with clamped workpiece 2. For example, the workpiece 2 is a rotation workpiece 19, for example a brake disc 20 having a rotation axis 24, such as it is used for example in motor vehicles 21 (compare FIG. 2). The workpiece 2 comprises an (in the picture upper) treatment surface 4, on which in the shown state a refinement layer 9 can be applied by means of the coating apparatus 1. To this end, the workpiece 2 is clamped into the tool chuck 3 of the coating apparatus 1 and held precisely positioned by it. In this embodiment, the tool chuck 3 is for example a clamping chuck having a rigid rotation axis 24 and the workpiece 2 is aligned coaxially to the rotation axis 24. Thus, the rotation axis 24 is aligned normal to the treatment surface 4.

According to the drawing, a coating unit 5 of the coating apparatus 1 is positioned above the workpiece 2. The coating unit 5 has an application axis 6 aligned parallel to the rotation axis 24. Purely optionally, the coating unit 5 comprises an application laser 16 arranged spaced from the application axis 6, wherein then by means of a purely optionally angled first translucent mirror 25 the application laser 16 is diverted within the coating unit 5 coaxially to the application axis 6. The workpiece 2 is then rotated about the rotation axis 24 (for example by means of a rotation drive, not shown here, of the tool chuck 3) and purely optionally, the coating unit 5 moves with a feed direction 8 radially to the outside (according to the picture to the right), such that the refinement layer 9 is applied approximately in the manner of a spiral onto the treatment surface 4 within a predefined current region 7 on the workpiece 2.

Here, now, the coating apparatus 1 comprises purely optionally two axial monitoring units 10, two inclined monitoring units 11 as well as a trailing monitoring unit 12, by means of which the application procedure (by means of the coating unit 5) on the treatment surface 4 is detected. The optical monitoring units 10, 11, 12 are to this end aligned onto the surface of the workpiece 2. Each of the monitoring units 10, 11, 12 is assigned a corresponding focus region 13, 14, 15.

The first axial monitoring unit 10 is purely optionally in the form of a pyrometer 18, which is arranged coaxially to the application axis 6 and is for example integrated in the coating unit 5. The (two) mirrors 25, 26, arranged according to the picture therebelow, are purely optionally translucent in form, such that the current focus region 13 for the pyrometer 18 is detectable through the mirror 25, 26 and a temperature detection of the applied refinement layer 9 is executable. The second axial monitoring unit 10 is purely optionally a video camera 17, which, according to the picture, is arranged on the right and perpendicularly spaced from the application axis 6. By means of a second translucent mirror 26, the axial monitoring unit 10 is then coupled into the application axis 6, such that for example a powder spray image of a supplied coating material is detectable. Both axial monitoring units 10 are aligned on the current focus region 13, that is, directly onto the region 7 in which the application procedure takes place.

Furthermore, a first inclined monitoring unit 11 is provided, purely optionally in the form of a video camera 17, which is arranged at a predefined angle to the application axis 6. This inclined monitoring unit 11 is to this end aligned onto a leading focus region 15, which is arranged at a predefined leading distance 22 (shown with a dotted line) to the application axis 6. Purely optionally, the running focus region 15 is arranged radially externally to the current region 7. For example, by means of this inclined monitoring unit 11, a detection of the quantity of the applied material is facilitated, for example by means of a detected height profile. In a further embodiment, furthermore, the current temperature in the leading focus region 15, for example on the treatment surface 4, is detected.

Purely optionally, a second inclined monitoring unit 11 is provided here, which according to the picture is arranged below the first inclined monitoring unit 11 and thus has a greater angle to the application axis 6. Purely optionally, the second inclined monitoring unit 11 is arranged separately from the coating unit 5 and comprises purely optionally a video camera 17 and a pyrometer 18, wherein here, purely optionally again, the11urrentt focus region 13 is detected. For example, it is thus facilitated to detect the temperature, as well as the height (that is the layer thickness) of the immediately applied refinement layer 9 in the current region 7.

Here, furthermore, a trailing monitoring unit 12 is provided, which, according to the picture, is arranged on the right hand purely optionally separately to the coating unit 5 and inclined to the application axis 6. Purely optionally, in addition thereto, the trailing focus region 14 is arranged radially-inside by means of a trailing distance 23 to the application axis 6. By means of the trailing monitoring unit 12, a cooling of the applied material as well as (purely optionally simultaneously) a height of the applied material, that is a layer thickness, is detectable.

Below the workpiece 2, according to the picture, for example a second video camera is provided as a second partial unit of the monitoring unit 11 (in a not shown here). By means of the second partial unit, thus the rear side of the workpiece 2 is detectable, which is arranged on the side of the workpiece 2 situated opposite to the treatment surface, that is, according to the picture, pointing downwards.

In FIG. 2 is shown a motor vehicle 21 with brake discs 20 in a schematic top view. The motor vehicle 21 has four wheels 27, wherein in each case two wheels 27 are arranged oppositely-situated on a common wheel axle. In this example, each of the wheels 27 has a brake disc 20, wherein wheel 27 and brake disc 20 are connected so as to be torque-resistant.

For example, on each of the two axially-opposite sides of the brake disc 20, a refinement layer 9 is applied by means of the coating apparatus 1 shown in FIG. 1. On each of the brake discs 20 is arranged a pair of brake pads 28, wherein the brake pads 28 are fixedly connected to the vehicle body. For decelerating the motor vehicle 21, a respective brake pad 28 is pressed against the respective brake disc 20 (each or individually regulated). The braking energy is transferred to a large extent into the respective brake disc 20 as waste heat, for which reason the refinement layer 9 is stressed at high temperatures and high shearing loads and high pressure. The refinement layer 9 needs to stand up to this stress case.

With the coating apparatus proposed here, the application quality is monitorable in-line in a coating method.

### LIST OF REFERENCE NUMERALS

1 Coating apparatus
2 Workpiece
3 Tool chuck
4 Treatment surface
5 Coating unit
6 Application axis
7 Current region
8 Feed direction
9 Refinement layer
10 Axial monitoring unit
11 Inclined monitoring unit
12 Trailing monitoring unit
13 Current focus region
14 Trailing focus region
15 Leading focus region
16 Application laser
17 Video camera
18 Pyrometer
19 Rotation workpiece
20 Brake disc
21 Motor vehicle
22 Leading distance
23 Trailing distance
24 Rotation axis
25 First translucent mirror
26 Second translucent mirror
27 Wheel
28 Brake pad

1-9 (canceled)

10. Coating apparatus for the surface refinement of a workpiece having at least the following components:
a tool chuck for holding a workpiece having a treatment surface;
a coating unit having an application axis for applying, in a region and along a feed direction, a refinement layer on that treatment surface; and
an optical monitoring unit, by means of which in a focus region an application procedure on that treatment surface is detectable,
wherein,
the focus region of the monitoring unit is aligned in the feed direction in front of the region and/or from inclined to the application axis (6) onto the region of the current application procedure.

11. Coating apparatus according to claim 10, wherein
furthermore a trailing monitoring unit having a trailing focus region is provided,
wherein the trailing focus region is aligned in feed direction behind the region of the current application procedure.

12. Coating apparatus according to claim 10, wherein
the coating apparatus comprises an application laser and furthermore an axial monitoring unit is provided,
wherein the axial monitoring unit is coupled into the application laser.

13. Coating apparatus according to claim 10, wherein
at least one of the monitoring units comprises a video camera and/or a pyrometer.

14. Coating apparatus according to claim 10, wherein
the workpiece is a rotation workpiece, preferably a brake disc for a motor vehicle.

15. Coating method according to claim 10, wherein the optical monitoring unit for determining the shielding has a first partial unit for the treatment surface and a second partial unit, in reference thereto, for calibrating a height profile of the rear side situated opposite the treatment surface, preferably simultaneously axially oppositely situated to the focus region of the first partial unit, and/or preferably simultaneously axially oppositely situated to the region of the current application procedure.

16. Coating method in the case of a surface refinement of a workpiece by means of a coating apparatus according to claim 10, wherein while a workpiece is held in the tool chuck the coating method comprises at least the following steps:
a. by means of the coating unit, applying a refinement layer onto that treatment surface along the feed direction; and
b. by means of the at least one monitoring unit, detecting the application procedure according to step a. on the treatment surface.

17. Coating method according to claim 16, wherein when detecting the application procedure in step b. at least one of the following items of information is determined, specifically a current temperature and/or a height profile:
in the region of the current application;
at a leading distance in feed direction before the region of the current application; and
at a trailing distance in feed direction after the region of the current application.

18. Coating method according to claim 16, wherein a shielding of the rotation workpiece is determined by means of said optical monitoring unit.
